(19) United States
(12) Patent Application Publication
(10) Pub. No.: US 2015/0061303 A1
(43) Pub. Date: Mar. 5, 2015

(54) Bolt Security Seal

(71) Applicant: NovaVision, Inc., Bowling Green, OH (US)

(72) Inventor: Min Zhou, Chengguan Town (CN)

(73) Assignee: NovaVision, Inc., Bowling Green, OH (US)

(21) Appl. No.: 14/326,891

(22) Filed: Jul. 9, 2014

Related U.S. Application Data
(60) Provisional application No. 61/870,261, filed on Aug. 27, 2013.

(51) Int. Cl. G09F 3/03

(52) U.S. Cl. CPC G09F 3/0317
USPC 292/327

(57) ABSTRACT

A bolt security seal has a bolt including a shaft having a non-cylindrical geometric shape. The seal further has a lock including a shaft opening having a non-cylindrical shape corresponding to the shape of the shaft. The shaft opening is configured for mating engagement with the shaft. The non-cylindrical shapes prevent rotational movement of the bolt and the lock with respect to one another once they are engaged.

### TECHNICAL FIELD

This invention relates generally to security devices for cargo. More specifically, the invention is directed to a bolt security seal.

### BACKGROUND OF THE INVENTION

Bolt security seals are used to secure, for example, the locking hasp of containers and truck trailers. Because these types of seals are for one-time use, they are removed using a cutting device after installation.

Thieves sometimes use a technique to “spin” these types of seals at high speed, which allows the seals to be removed with no obvious damage and reused. This is often done by attaching a portable drill to the head portion of the seal and holding the locking portion with a clamping device such as pliers. This invention provides a bolt security seal that prevents spinning

### BRIEF SUMMARY OF THE INVENTION

A bolt security seal has a bolt including a shaft having a non-cylindrical geometric shape. The seal further has a lock including a shaft opening having a non-cylindrical shape corresponding to the shape of the shaft. The shaft opening is configured for mating engagement with the shaft. The non-cylindrical shapes prevent rotational movement of the bolt and the lock once they are engaged to one another.

### BRIEF DESCRIPTION OF THE DRAWINGS

FIG. 1 is a perspective view of an embodiment of a bolt security seal according to the invention;

FIG. 2 is a cross-sectional view taken along line 2-2 of FIG. 1;

FIG. 3 is a cross-sectional view taken along line 3-3 of FIG. 1;

FIG. 4 is a view similar to view of FIG. 2 showing an alternative embodiment of a bolt security seal according to the invention;

FIG. 5 is a view similar to view of FIG. 2 showing an alternative embodiment of a bolt security seal according to the invention;

FIG. 6 is a view similar to view of FIG. 2 showing an alternative embodiment of a bolt security seal according to the invention;

FIG. 7 is a view similar to view of FIG. 2 showing an alternative embodiment of a bolt security seal according to the invention;

FIG. 8 is a perspective view showing a bolt security seal according to the invention in use;

FIG. 9 is a cross-sectional view taken through the center of an alternative embodiment a bolt security seal according to the invention; and

FIG. 10 is a perspective view showing the interaction of the spring and the bolt of the embodiment of the invention shown in FIG. 9.

### DETAILED DESCRIPTION OF THE INVENTION

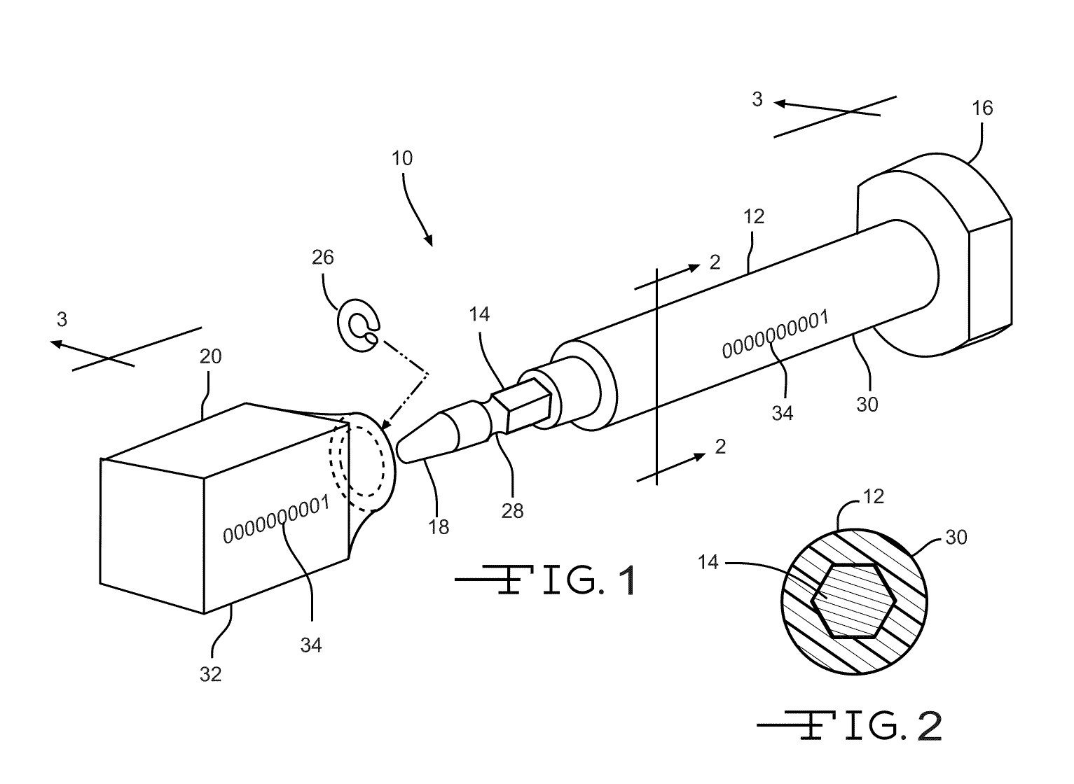

Referring to the drawings, a bolt security seal according to the invention is indicated generally by the reference number “10.” As shown in FIGS. 1-3, the bolt security seal 10 includes a bolt 12 having a shaft 14 extending longitudinally between an enlarged head 16 and a tapered tip 18. The seal 10 further includes a lock 20 having a shaft opening 22 that is sized and adapted for mating engagement with the shaft 14. Both the shaft 14 and the opening 22 have non-cylindrical geometric shapes to prevent rotational movement of the bolt 12 and the lock 20 once they are engaged to one another. In an embodiment, the bolt 12 and the lock 20 are made of metal.

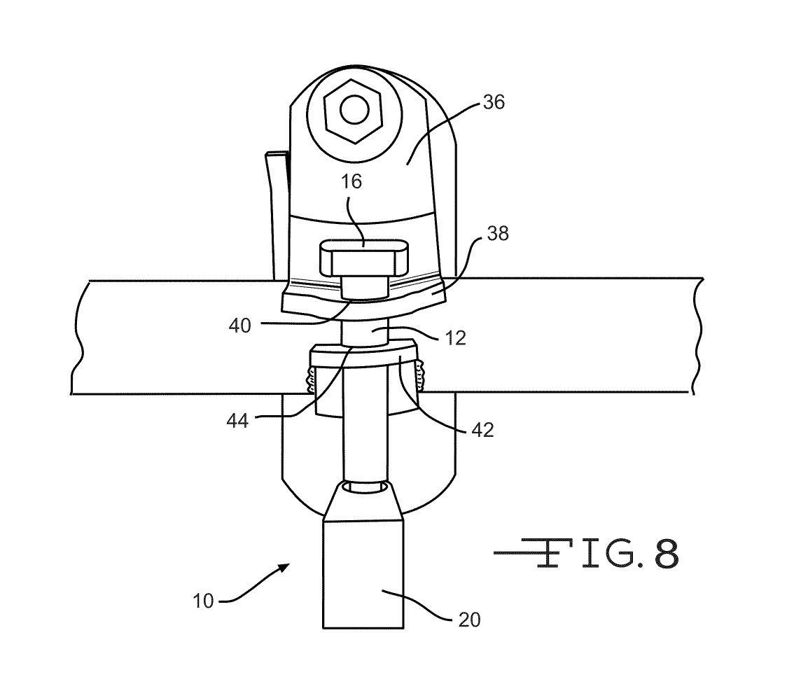

Referring to FIG. 2, the geometric shapes of the shaft 14 and the opening 22 are hexagonal. In other embodiments the geometric shapes are triangular (FIG. 4), oval (FIG. 5), square (FIG. 6) and pentagonal (FIG. 7). It should be understood that the shaft 14 and the opening 22 can have a variety of other non-cylindrical shapes depending on the application.

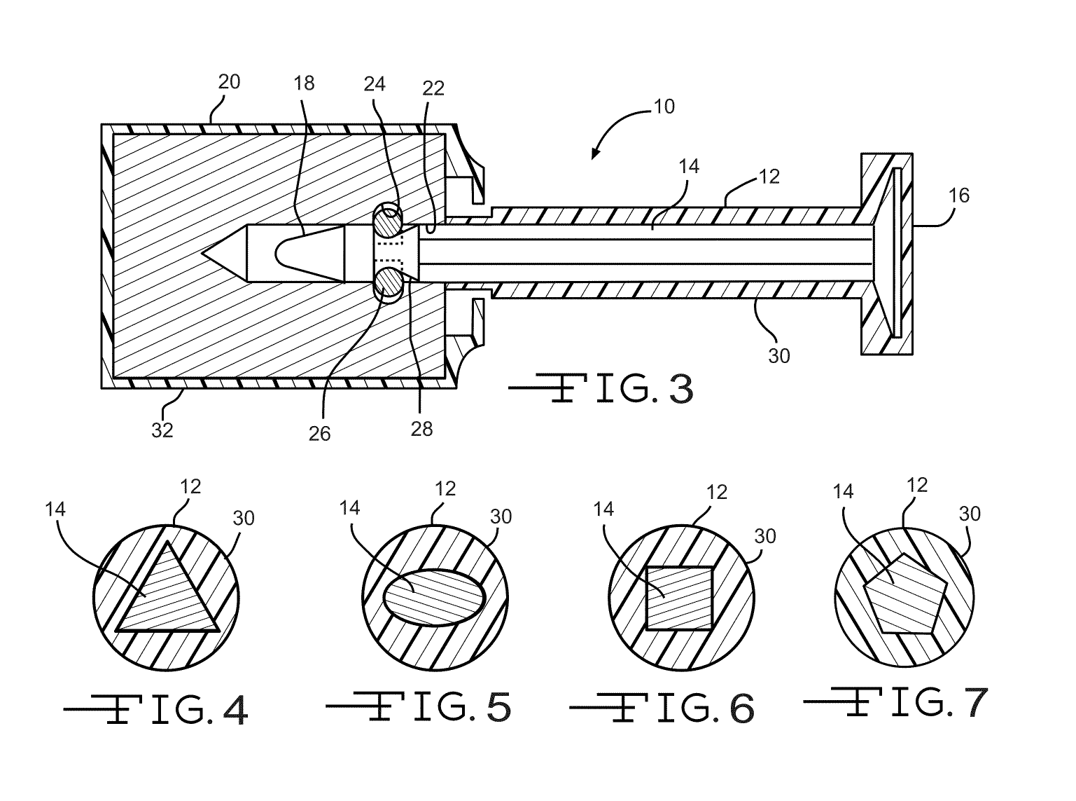

Referring to FIGS. 1 and 3, the lock 20 includes a lock groove 24 positioned adjacent to the opening 22 in which a resilient split locking ring 26 is positioned. The shaft 14 includes a shaft groove 28 positioned adjacent to the tip 18 that is sized and adapted for the insertion of the locking ring 26. In an embodiment, the locking ring 26 is made of metal.

Still referring to FIGS. 1 and 3, a bolt coating 30 can be positioned on the bolt 12. A lock coating 32 can be positioned on the lock 20. In an embodiment, the bolt and lock coatings 30 and 32 are made of plastic. In an embodiment, the bolt and lock coatings 30 and 32 include indicia 34, such as numbers, to identify the seal 10.

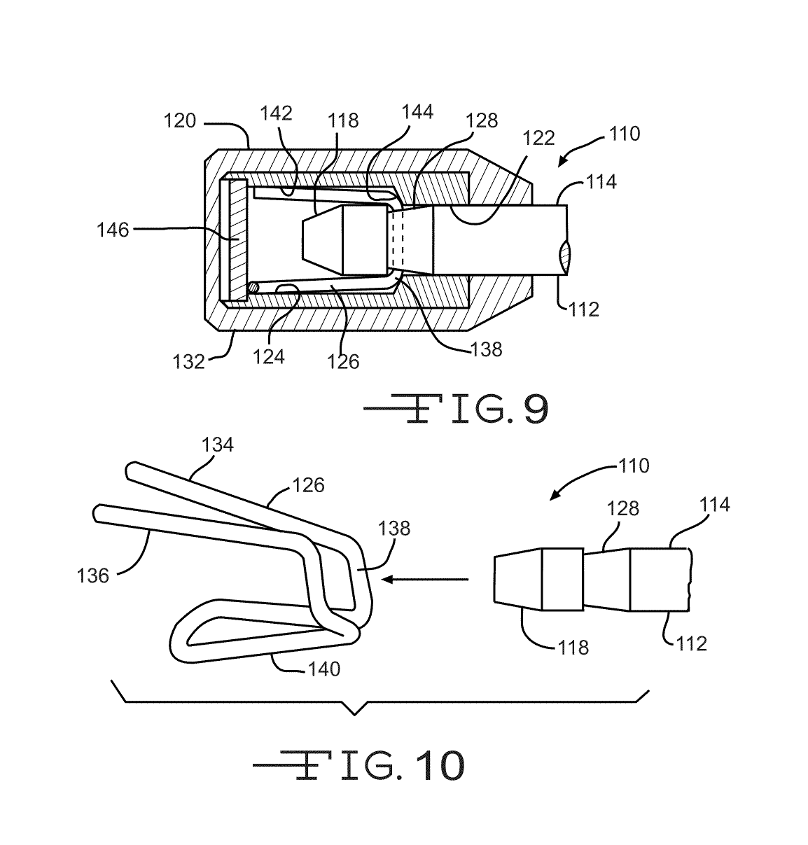

Referring to FIGS. 1-3 and 8, the seal 10 is positioned on, for example, a locking hasp 36 including a first member 38 having a first opening 40 and a second member 42 having a second opening 44. In this regard, the bolt 12 is inserted in the first and second openings 40 and 42. The head 16 prevents the bolt 12 from passing through the first opening 40. The tip 18 of the shaft 14 is inserted in the shaft opening 22 of the lock 20. During insertion, the tip 18 separates the locking ring 26 so that the tip 18 can pass through. The locking ring 26 is then inserted in the shaft groove 28, as shown in FIG. 3, to lock the bolt 12 to the lock 20. As shown in FIG. 8, the lock 20 is sized and adapted to prevent the lock 20 from passing though the second opening 44. As it will be appreciated, the non-cylindrical geometric shapes of the shaft 14 and the shaft opening 22 prevent the seal 10 from being spun once it has been positioned on the hasp 36.

Referring to FIGS. 9 and 10, an alternative embodiment bolt security seal 110 is shown. In this embodiment, the seal 110 includes a bolt 112 having a shaft 114 with a tapered tip 118. The seal 110 further includes a lock 120 having a shaft opening 122 that is sized and adapted for mating engagement with the shaft 114. Both the shaft 114 and the shaft opening 122 have non-cylindrical geometric shapes, as described above and shown in the drawings, to prevent rotational movement of the bolt 112 and the lock 120 once they are engaged to one another. In an embodiment, the bolt 112 and the lock 120 are made of metal.

Still referring to FIGS. 9 and 10, the lock 120 includes a spring chamber 124 positioned adjacent to the shaft opening 122 in which a resilient locking spring 126 is positioned. The shaft 114 includes a shaft groove 128 positioned adjacent to the tip 118 that is sized and adapted for the insertion of the locking spring 126. In an embodiment, the locking spring 126 is made of metal. A lock coating 132 can be positioned on the lock 120. In an embodiment, the lock coating 132 is made of plastic. In an embodiment, the lock coating 132 includes indicia, as described above and shown in the drawings.

Still referring to FIGS. 9 and 10, the locking spring 126 is generally V-shaped and includes a first foot 134, a second foot 136, a spring opening 138 and a support portion 140. As shown in FIG. 9, the locking spring 126 is positioned in the spring chamber 124 so that the spring opening 138 is positioned adjacent to the shaft opening 122. In an embodiment, the locking spring 126 engages a chamber wall 142, which includes a chamfer 144, and a spring plate 146.

Referring to FIGS. 8-10, the seal 110 can be used as described above with respect to the seal 10. In this regard, the tip 118 of the shaft 114 is inserted in the shaft opening 122 of the lock 120. During insertion, as shown in FIG. 10, the tip 118 separates the locking spring 126 so that the tip 118 can pass through the spring opening 138. The locking spring 126 is then inserted in the shaft groove 128, as shown in FIG. 9, to lock the bolt 112 to the lock 120. The non-cylindrical geometric shapes of the shaft 114 and the shaft opening 122 prevent the seal 110 from being spun once the shaft 114 is positioned in the shaft opening 112.

Certain embodiments of the apparatus disclosed herein are defined in various examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A bolt security seal comprising:
a bolt including a shaft having a non-cylindrical geometric shape; and
a lock including a shaft opening having a non-cylindrical geometric shape corresponding to the shape of the shaft, the shaft opening being adapted for mating engagement with the shaft to prevent rotational movement of the bolt and the lock with respect to one another once they are engaged.

2. The bolt security seal of claim 1, wherein the shapes of the shaft and the shaft opening are substantially hexagonal.

3. The security seal of claim 1, wherein the shapes of the shaft and the shaft opening are substantially triangular.

4. The bolt security seal of claim 1, wherein the shapes of the shaft and the shaft opening are substantially oval.

5. The bolt security seal of claim 1, wherein the shapes of the shaft and the shaft opening are substantially square.

6. The bolt security seal of claim 1, wherein the shapes of the shaft and the shaft opening are substantially pentagonal.

7. The bolt security seal of claim 1, wherein the bolt has an enlarged head.

8. The bolt security seal of claim 1, wherein the bolt has a tapered tip.

9. The bolt security seal of claim 1, wherein the bolt has a shaft groove.

10. The bolt security seal of claim 1, wherein the lock has a lock groove.

11. The bolt security seal of claim 1, wherein the lock has a resilient split locking ring.

12. The bolt security seal of claim 1, wherein the lock has a spring chamber.

13. The bolt security seal of claim 12, wherein the spring chamber has a chamfer.

14. The bolt security seal of claim 1, wherein the lock has a resilient locking spring.

15. The bolt security seal of claim 14, wherein the locking spring is generally V-shaped and includes a first foot, a second foot, a spring opening and a support portion.

16. The bolt security seal of claim 1, wherein the bolt includes a coating.

17. The bolt security seal of claim 1, wherein the bolt includes indicia.

18. The bolt security seal of claim 1, wherein the lock includes a coating.

19. The bolt security seal of claim 1, wherein the lock includes indicia.

20. The bolt security seal of claim 1, wherein the bolt and the lock include indicia.
